(19) United States
(12) Patent Application Publication
(10) Pub. No.: US 2017/0178156 A1
(43) Pub. Date: Jun. 22, 2017

(54) MEASURING PARTICIPANT PERCEPTIONS

(71) Applicants: Sean M. Bruich, Palo Alto, CA (US); Frederick R. Leach, Palo Alto, CA (US); Ellen Konar, Palo Alto, CA (US)

(72) Inventors: Sean M. Bruich, Palo Alto, CA (US); Frederick R. Leach, Palo Alto, CA (US); Ellen Konar, Palo Alto, CA (US)

(73) Assignee: GOOGLE INC., Mountain View, CA (US)

(21) Appl. No.: 12/186,293

(22) Filed: Aug. 5, 2008

Related U.S. Application Data
(60) Provisional application No. 61/051,254, filed on May 7, 2008.

(51) Int. Cl. G06Q 30/00; G06Q 10/00

(52) U.S. Cl. CPC G06Q 30/0202; G06Q 30/0244

(57) ABSTRACT

Methods, systems, and apparatus, including computer program products, for measuring strengths of associations between branding content and branding content. In an aspect, branding content associations are collected from sessions of psychometric tools for branding content at client devices. Determined are orders of mention defining an order in which the branding content associations were input at each of the client devices, frequencies of mention for each of the branding content associations, and latencies of mention for each of the branding content associations. One or more of these metrics can be used to determine association strengths for each branding content association.

This Nonprovisional patent application claims the benefit of priority to Provisional Patent Application Ser. No. 61/051,254, entitled “Measuring Participant Perceptions,” filed on May 7, 2008, the entire disclosure of which is incorporated herein by reference.

### BACKGROUND

This specification relates to measuring brand perceptions of participants using an on-line psychometric tool.

The Internet provides access to a wide variety of content items, e.g., video and/or audio files, web pages for particular subjects, news articles, etc. Such access to these content items has likewise enabled opportunities for targeted advertising. For example, content items of particular interest to a user can be identified by a search engine in response to a user query. The query can include one or more search terms, and these terms can indicate the user's current interests. By comparing the user query to a list of keywords specified by an advertiser, it is possible to provide targeted advertisements to the user.

Another form of online advertising is advertisement syndication, which allows advertisers to extend their marketing reach by distributing advertisements to additional partners. For example, third party online publishers can place an advertiser's text or image advertisements on web pages that have content related to the advertisement. As the users are likely interested in the particular content on the publisher webpage, they are also likely to be interested in the product or service featured in the advertisement.

Increasing sales and/or building brand equity are goals of many advertising campaigns. With respect to the latter goal, advertisers often seek to understand how consumers in their target market perceive their brand or product. Perceptions of a brand can be understood by associations with that brand or product, particularly those associations stored in long term memory. Such associations can provide advertisers with valuable insights into factors in purchasing decisions, the impact of public relations and advertising and can provide a strategic basis for developing or refining a marketing strategy. For example, if the typical target consumer's schema for a particular automobile brand includes such associations such as comfortable, economical, practical, but also slow and unreliable, the automobile manufacturer's marketing opportunity for gaining share in automotive sales is substantially different than if the associations were expensive, luxury, etc.

There are many research approaches that have been used to provide advertisers the basis for understanding the perceptions of an audience. One approach is conducting a survey in which the respondent is presented with a series of descriptions (awesome, fun, expensive) and asked to indicate how well the terms apply to a series of products or brands, including the brand of interest and significant competitors. This approach, however, is sometimes prone to and reflects the biases of the author of the survey. This approach in many ways assumes knowledge of the dimensions on which a brand is likely to be evaluated

Another approach is to ask indirect questions (e.g., if Brand X were a runner, what type of runner would it be?) that presumably minimize executive control brain function (e.g., the respondent's ability to provide answers that are desirable to the questioner or socially appropriate) and provide supposedly better insights into the latent attitudes or opinions of the respondent. A related approach is to ask survey participants to select from a pile of pictures of random objects, people, situations, those objects, people and situations that they associate with the brand that is the subject of the survey. This approach, however, may be prone to the subjective interpretations of the researchers and has not been shown to be reliable, predictable or scalable for tracking over time.

Another approach is to elicit associations from participants directly via open ended questions that are not subject to an input constraint, such as a time limit. Most simply, one could ask in a survey format “When you think of Brand X, what comes to mind?” This approach, however, has limitations. In the context of a survey, participants often seek to minimize their responses; most don't answer such questions at all, and those that do often provide only their first thought and nothing more. Moreover, respondents in such a survey frequently give answers that reflect what they think the questioner is looking for, rather than their own actual sentiments.

### SUMMARY

In general, one aspect of the subject matter described in this specification can be embodied in methods that include the actions of identifying branding content for a client device; and providing a psychometric tool to the client device, the psychometric tool directed to the branding content and including an input interface that receives perception data subject to an input condition and input by a participant using the client device and an input condition indicator that indicates an expiry status of an input condition; wherein when the expiry status of the input condition is true the input of perception data at the input interface is precluded and when the expiry status of the input condition is false the input of perception data at the input interface allowed. The perception data that is input can be branding content associations. The data can also include an order of mention that defines the order in which the branding content associations were input; a frequency of mention that defines how often each branding content association was input relative to the number of administrations of the psychometric tool and/or all branding content associations; and latency of mention that defines the times at which the banding content associations were input during the administration of the psychometric tools. The order of mention, frequency of mention and latency of mention can be used to determine a strength of association between each branding content association and the branding content. Other embodiments of this aspect include corresponding systems, apparatus, and computer program products.

Another aspect of the subject matter described in this specification can be embodied in methods that include the actions identifying branding content associations for branding content; determining an order of mention for each of the branding content associations; determining a frequency of mention for each of the branding content associations; determining a latency of mention for each of the branding content associations; and for each branding content association, determining an association strength that measures a strength of association of the branding content association to the branding content, the association strength based on one or more of the order of mention, frequency of mention and the latency of mention of the branding content association. Other embodiments of this aspect include corresponding systems, apparatus, and computer program products.

Various optional advantages and features can include the eliciting of associations in a game-like format in which participants are constrained to provide associations subject to an input constraint minimizes the effect of executive control. A participant can be paired with one or more simultaneous participant and/or one or more previous participants and a score that is based on matching or similar associations can be generated to further minimize the effect of executive control. A variety of association input metrics can be used to determine association strengths based on or more of the metrics. Administration of the psychograph tool can be done in an on-line environment and is thus highly scalable. These various optional advantages and features can be separately realized and need not present in any particular embodiment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a perception measurement system can be implemented.

FIGS. 2A-2C are example screenshots of an advertisement that includes branding content and of a psychometric tool directed to a portion of the branding content.

FIG. 3 is an illustration of a perceptual map of brand associations based on perception data received from administration of psychometric tools.

FIG. 4 is an illustration of a brand competitive profile based on perception data received from the administration of psychometric tools.

FIG. 5 is a flow diagram of an example process for administering a psychometric tool.

FIG. 6 is a flow diagram of an example process for generating a score for display on a device on which a psychometric tool is being administered.

FIG. 7 is a flow diagram of an example process for determining a strength of association based on perception data received in response to administrations of psychometric tools.

FIG. 8 is a block diagram of an example computer processing system that can be used to facilitate measuring participant perceptions.

Like reference numbers and designations in the various drawings indicate like elements.

### DETAILED DESCRIPTION

### §1.0 Overview

In general, the subject matter of this specification relates to measuring participant perceptions for a brand by a psychometric tool presented in a format in which participants, e.g., target consumers, are presented with branding content, e.g., logos, brands, service marks, and are encouraged under time pressure to provide as many top of mind associations as possible. The psychometric tool defines an input condition, e.g., a fixed period of time, under which participants can input as many associations as possible. The input condition can be selected to reduce the role of the executive control function of each participant so that more truthful and uncensored associations with the branding content are provided. In some implementations, the participant is paired with one or more prior or simultaneous participant(s), and points are awarded for matching associations with individual participants or to an average group response. The administration of the psychometric tool can be implemented through an on-line user interface that can be accessed from an advertisement, or from an advertisement gadget, or from any other user interface designed to elicit and collect information.

Example data that can be collected and/or derived include associations, the frequency mention of the associations, the order of mention of the associations, and the latency of mention of the associations. The frequency mention of the associations, the order of mention of the associations, and the latency of mention of the associations can be used to determine a strength of association for each association. The results can also be segmented based on participant characteristics such as demographics.

### §1.1 Advertising Environment

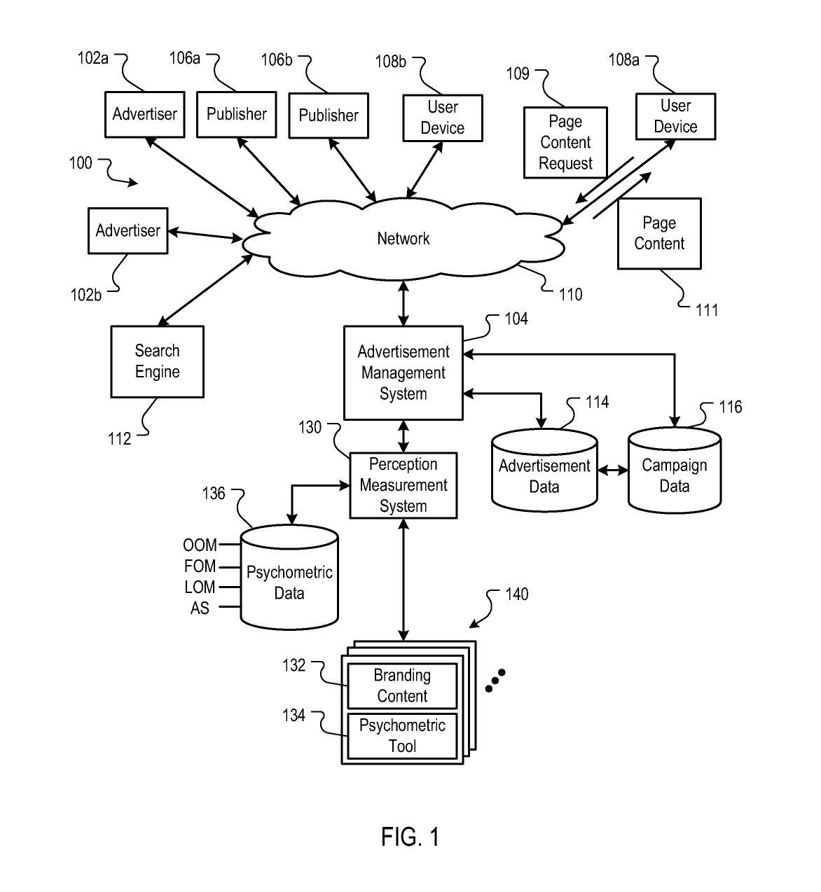

FIG. 1 is a block diagram of an example online environment 100 in which a perception measurement system can be implemented. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (106a and 106b) and two user devices (108a and 108b) are shown, the online environment 100 may include many thousands of advertisers, publishers and user devices.

### §1.2 Advertisement Publishing and Tracking

One or more advertisers 102a and/or 102b can directly, or indirectly, enter, maintain, and track advertisement information in the advertising management system 104. The advertisements can be in the form of graphical advertisements, such as banner advertisements, text only advertisements, image advertisements, audio advertisements, video advertisements, advertisement gadgets with or without interactive features, advertisements combining one of more of any of such components, etc., or any other type of electronic advertisement document 120. The advertisements may also include embedded information, such as a links, meta-information, and/or machine executable instructions, such as HTML or JavaScript™. The advertisement can be submitted, for example, as a single advertisement creative, in a group of related advertisements as an advertisement group, or in multiple advertisement groups that form an advertisement campaign.

A user device, such as user device 108a, can submit a page content request 109 to a publisher or the search engine 112. In some implementations, the page content 111 can be provided to the user device 108a in response to the request 109. The page content can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, television set-top boxes, game consoles, etc.

Advertisements can also be provided for the publishers 106. For example, one or more publishers 106a and/or 106b can submit advertisement requests for one or more advertisements to the system 104. The system 104 responds by sending the advertisements to the requesting publisher 106a or 106b for placement on one or more of the publisher's web properties (e.g., websites and other network-distributed content). Alternatively, the system 104 responds by sending the advertisement directly to the user device 108a in response to a user device request for page content 111 from the one or more publishers 106a and/or 106b, typically via instructions embedded in the page content 111 received by the user device 108a from the publishers 106a and/or 106b.

The advertisements can include embedding links landing pages, e.g., pages on the advertisers 102 websites, that a user is directed to when the user clicks an ad presented on a publisher website. The advertisement requests can also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, a publisher 106 can combine the requested content with one or more of the advertisements provided by the system 104. This combined page content and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104, including information describing how, when, and/or where the advertisements are to be rendered (e.g., in HTML or JavaScript™).

Publishers 106a and 106b can include general content servers that receive requests for content (e.g., articles, discussion threads, audio, video, graphics, search results, games, software, web page listings, information feeds, etc.), and retrieve the requested content in response to the request. For example, content servers related news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). The search engine 112 can also submit a request for advertisements to the system 104. The request for advertisements may also include the query (as entered or parsed), information based on the query (such as geo-location information, whether the query came from an affiliate and an identifier of such an affiliate), and/or information associated with, or based on, the search results.

The search engine 112 can combine the search results with one or more of the advertisements provided by the system 104. This combined information can then be forwarded to the user device 108 that requested the content as the page content 111. The search results can be maintained as distinct from the advertisements, so as not to confuse the user between paid advertisements and presumably neutral search results.

Advertisements and associated usage data can be stored as advertisement data in an advertisement data store 114. In some implementations, an advertiser 102 can further manage the serving of advertisement by specifying an advertising campaign. The advertising campaign can be stored in campaign data in a campaign data store 116 that can, for example, specify advertising budgets for advertisements, when, where and under what conditions particular advertisements may be served for presentation, etc.

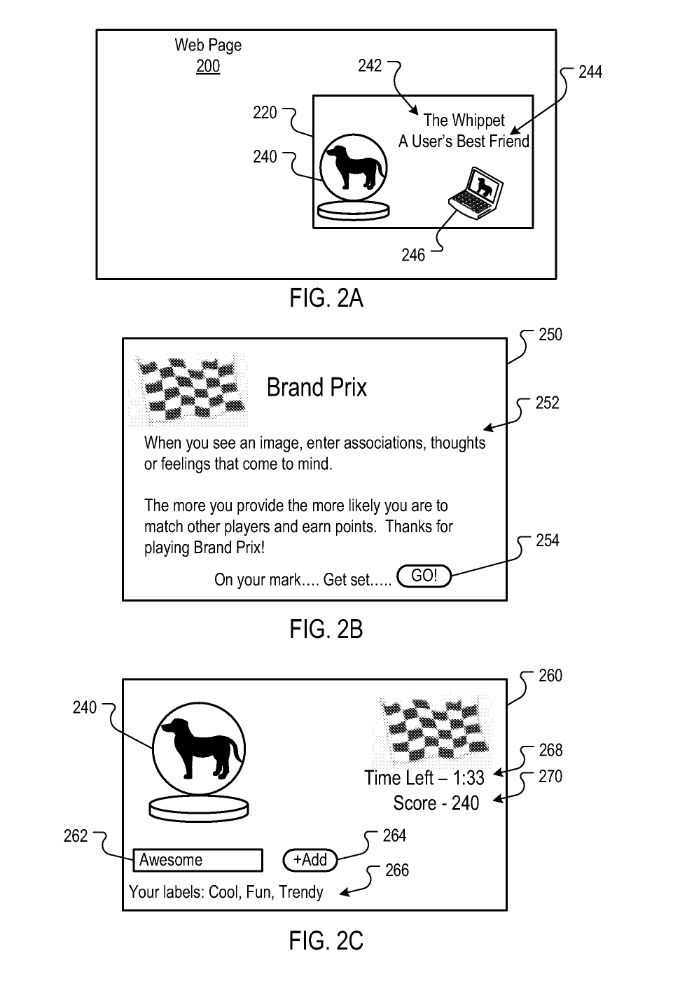

An example illustration of an advertisement for a product (a laptop computer) is shown in FIG. 2A, which depicts a displayed advertisement 220 being presented in one of potentially several contexts on a web page 200, e.g., either as an advertisement listed in response to a search query, or as an advertisement selected and displayed based on the content of an underlying web page, or based on some other context. The advertisement 220 can be displayed on a computer device, such as a user device 108.

The advertisement 220 can, for example, be one of several or more advertisements for use in an advertising campaign. The advertisement 220 can included branding content, such as a brand logo, a slogan, a service mark, a brand mark, audio branding content (e.g., a short song, spoken slogan, or audio marketing feature), video branding content (e.g., a video clip, or a commercial), or any other marketing-related communication that relates to a brand. As shown in FIG. 2A, the branding content includes a logo 240, and product brand name 242, “Whippet,” a slogan 244, “A User's Best Friend,” and an image 246 of the product.

### §2.0 Measuring Brand Perception

In some implementations, a perception measurement system 130 that measures audience perception of branding content can be used in conjunction with the advertising management system 104. In the example implementation of FIG. 1, the perception measurement system 130 is a subsystem of the advertisement management system 104. In other implementations, the perception measurement system 130 can be a separate system that can operate independently of the advertisement management system 104.

The perception measurement system 130 can be realized by instructions that upon execution cause one or more processing devices to carry out the processes and functions described below. Such instructions can, for example, comprise interpreted instructions, such as script instructions, e.g., JavaScript or ECMAScript instructions, or executable code, or other instructions stored in a computer readable medium. The perception measurement system 130 can be distributively implemented over a network, such as a server farm, or can be implemented in a single computer device.

### §2.1 Client Psychometric Tool

In some implementations, the perception measurement system 130 provides psychometric tool code 140 to the user devices 108. In some implementations, the psychometric tool code 140 can include branding content 132 and can also define a psychometric tool 134. When received by a user device 108, the psychometric tool code 140 causes the user device to display the branding content 132 and administer the psychometric tool 134. The psychometric tool 134 is directed to the branding content 132 and includes an input interface that receives perception data input by a participant using the client device 108, and an input condition indicator that indicates an expiry status of the input condition.

The input of perception data at the input interface is subject to the input condition so that input of the perception data is precluded when the expiry status of the input condition is true and input of the perception data is allowed when the expiry status of the input condition is false. In some implementations, the input condition is a fixed period of time, e.g., two minutes, and the input condition indicator is a countdown clock.

In some implementations, the psychometric tool 134 can measure a perception variable. The psychometric tool 134 can, in some implementations, also measure other variables, such as one or more of a value variable, attitude variable, demographic variable and lifestyle variable. In some implementations, the psychometric tool 134 can be a survey, such as a branding survey that elicits the input of associations from participants.

In some implementations, the display of branding content 132 is optional. For example, the psychometric tool code 140 may only include the psychometric tool 134, and the psychometric tool may identify the branding content 132 to the participant. Thus, instead of displaying a brand logo for a product, the psychometric tool 134 may pose the question “When you hear the word “X,” what thoughts come to mind?” where X is the brand name of the product.

In some implementations, the input is a text field and the perception data are branding content associations input by the participant. FIGS. 2B and 2C illustrate screenshots of an example implementation in which a psychometric tool is used to gather branding content associations for a portion of the branding content of the advertisement 220 of FIG. 2A. In particular, FIG. 2B is an example screenshot of a psychometric tool launch screen 250 that includes instructions 252 for the participant. The instructions 252 instruct the participant to enter branding content associations during the administration of the psychometric tool. Selection of the “Go” button initiates display of branding content and the psychometric tool on a user device 108.

FIG. 2C is a screenshot of an example psychometric tool 260. The psychometric tool 260 includes the branding content 240, the input text field 262, an add button 264, and an input label list 266. To input a branding content association, a user inputs the branding content association into the input text field 262 and selects the add button 264. Once input, the branding content association is appended to the input label list 266.

The input of the branding content associations through the input text field 262 is subject to the input condition, e.g., subject to a time period. A countdown clock 268 displays a graphical representation of the time period. As long as the countdown clock 268 has available time, the expiry status of the input condition is false, and the participant can input perception data into the text field 262. However, upon the countdown clock 260 counting down to 0 seconds, the expiry status is true, and the input of perception data is precluded. In response to the time period expiring, the psychographic tool can again be administered for different branding content 132.

Although a time period input condition has been described, other input conditions can also be used. For example, an input condition can be defined as the first five (or ten, etc.) branding content associations entered by the participant; or can be a time period incremented by a set amount of time (e.g., five seconds) each time a branding content association is entered by a participant; or can be a number of similar responses given by a group of simultaneous participants; etc.

In some implementations, input can instead be provided by use buttons or icons with content associations from previous participants, particularly for user devices such as, for example, mobile phones or touchscreens.

In some implementations, the perception data can be segmented by demographics of the participants. For example, a participant can opt-in to provide demographic data, e.g., age, gender, income, etc., before or after participating in one or more psychometric tool secessions, e.g., surveys. The demographic data can be associated with the participant data entered by the participant, and can thus be partitioned or segmented by common segmentation techniques.

### §2.2 Perception Data Metrics

In some implementations, the psychometric tool code 140 can be provided to a plurality of user device 108, and perception data input by the participants at each of the client devices 108 are received and stored as psychometric data 136. In some implementations, the perception measurement system 130 can also determine from the received perception data order of mention (OOM) data, frequency of mention (FOM) data, latency of mention (LOM) data, and association strength (AS) data.

In some implementations, the order of mention identifies an order in which the branding content associations are input at each user device 108. In some implementations, the order of mention can be aggregated for all perception data received according to a central tendency, e.g., an average or median position in which the branding content associations are received. Thus, in some implementations, the psychometric data 136 stores order of mention data for each psychometric tool session conducted at a user device and aggregate order of mention data for all sessions.

In some implementations, the latency of mention data identifies a measure of an occurrence time, e.g., and input time, of a corresponding branding content association relative to occurrence times, e.g., input times, of other branding content associations input during the administration of the psychometric tool. For example, if a user input four branding content associations, BC1-BC4, at times of 10 seconds, 20 seconds, 30 seconds and 40 seconds, respectively, then the latency of mention for each of BC1-BC4 can be 10, 20, 30 and 40 seconds.

In some implementations, the latency of mention can be aggregated for all branding content associations received according to a central tendency, e.g., an average or median time in which the branding content associations were input at the user devices. For example, average latency of mentions for the branding content associations BC1-BC4 could be 8 seconds, 30 seconds, 4 seconds, and 33 seconds, respectively. Thus, in some implementations, the psychometric tool data 136 stores latency of mention data for each psychometric tool session conducted at a user device and aggregate latency of mention data for all sessions.

In some implementations, the frequency of mention data identifies a frequency measure for each branding content association. In some implementations, the frequency measure can include a measure of the occurrence of a corresponding branding content association being input relative to all of the branding content associations being input, e.g., if 40,000 branding content associations are received, and a particular branding content associations is receive 4,000 times, then its corresponding frequency of mention is 10%. Other frequencies of mention can also be used. For example, a particular branding content association may be received more than once during an administration of a psychometric tool, e.g., a participant may enter the branding content association “trendy” several times during a single administration session. Thus, in some implementations, the frequency of mention can also include the number of times the branding content association was entered during a single session (e.g., 1, 2, or 3), or can include the average or median number of times the branding content association was mentioned for all sessions on a per-session basis (e.g., 1.04, 1.10, 1.31).

From the stored psychometric tool data 136, the perception measurement system 130 can determine an association strength for each branding content association. Each association strength measures a strength of association of the branding content association to the branding content. For example, if the product advertised in FIG. 2A is perceived by many participants to be “Fun” and “Trendy,” and is only rarely perceived to be “Boring,” then the associations strengths for the branding content associations of “Fun” and “Trendy” will be much stronger than the association strength for “Boring.”

In some implementations, the association strength for each branding content association can be based on one or more of the order of mention data, frequency of mention data and the latency of mention data of the branding content association. In general, a higher order of mention and a higher frequency of mention are signals of a stronger strength of association between a branding content association and the branding content. Conversely, a higher latency of mention is indicative of a lower strength of association. Thus, in some implementations, the association strength for each branding content association can be inversely proportional to the latency of mention of the branding content association, and directly proportional to the frequency of mention and the order of mention of the branding content association.

The association strength can be determined according to different functional relationships. These relationships can be based on the importance attributed to each metric by the advertiser, or by other subjective or objective criteria. In some implementations, a logarithmic function of the order of mention, latency of mention and frequency of mention can be used so that association strengths asymptotically approach a maximum and/or minimum limit. Other relations can also be used, e.g., linear and non-linear functions based on the order of mention, frequency of mention, and latency of mention data.

In other implementations, association strengths can be partitioned according to each of the order of mention, frequency of mention, and latency of mention. Table 1 below provides example association strengths for four branding content associations BCA1-BCA4 that are based on order of mention, frequency of mention, latency of mention, and functions of these values.

TABLE 1
Example Association Strengths

| | | | | F(FOM)/ | F(FOM)/ |
|---|---|---|---|---|---|
| BCA | OOM | FOM | LOM | F(Log(OOM)) | F(Log(OOM, LOM)) |
| BCA1 | 1.00 | 0.92 | 1.00 | 0.92 | 0.92 |
| BCA2 | 1.20 | 1.00 | 3.00 | 0.93 | 0.96 |
| BCA3 | 1.70 | 0.89 | 2.00 | 0.72 | 0.83 |
| BCA4 | 1.90 | 0.94 | 3.30 | 0.74 | 0.82 |

The corresponding rankings by association strengths are shown in Table 2 below.

TABLE 2
Example Rankings By Association Strengths

| | | | F(FOM)/ | F(FOM)/ |
|---|---|---|---|---|
| OOM | FOM | LOM | F(Log(OOM)) | F(Log(OOM, LOM)) |
| BCA1 | BCA2 | BCA1 | BCA2 | BCA2 |
| BCA2 | BCA4 | BCA3 | BCA1 | BCA1 |
| BCA3 | BCA1 | BCA2 | BCA4 | BCA3 |
| BCA4 | BCA3 | BCA4 | BCA3 | BCA4 |

In some implementations, perception data for each item of branding content presented during administration of the psychometric tool can be aggregated for all branding content of a brand. For example, for the product of FIG. 2A, a series of administrations can cycle through the logo 240, the product brand name 242, the slogan 244, and the image 246 of the product. In some implementations, the responses (e.g., associations) can be segmented for each type of branding content 132. In other implementations, the response can be aggregated for related branding content, e.g., the response for the product brand name 242, the slogan 244, and the image 246 can all be aggregated into one set of associations to determine association strengths for all branding content associations collected.

### §2.3 Participant Pairing

The input condition helps reduce executive control of the participant. In some implementations, executive control can be further reduced by pairing the participant with a prior or simultaneous participant or a prior or a simultaneous group of participants, and awarding points when matching associations are provided. In these implementations, the psychometric tool 260 can include a score indicator 270 that displays a common score. The common score can be incremented based on a similarity of branding content associations input at the client device to the branding content associations of the other simultaneous participant(s) or the previous participant(s).

For a simultaneous participant pairing, the participant measuring system 130 can coordinate a simultaneous administration of the psychometric tool so that a participant can be paired with another participant or group of participants and the input of branding content associations at the input interfaces of each client device of the participants can be simultaneously subjected to the input condition, e.g., a time limit. Branding content associations received from the client devices can be compared, either at the perception measurement system or at the respective user devices, and the common scores can be generated and displayed.

For a prior participant pairing, the branding content associations of one or more previous participant(s) can be compared to the branding content associations of the paired participant. In some implementations, the order of mention and latency of mention associated with the branding content associations of the previous participant(s) are used to simulate the inputting of branding content associations by the previous participant.

### §3.0 Example Graphical Data Displays

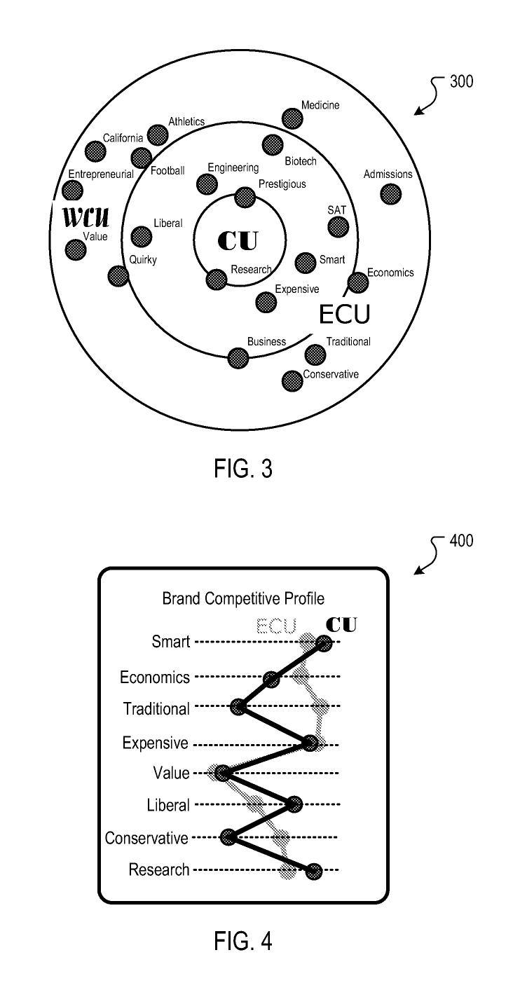

The psychometric data 136 can be further used to facilitate graphical representations of associations with brands. For example, FIG. 3 is an illustration of a perceptual map 300 of brand associations based on perception data received from administration of psychometric tools. The perceptual map 300 is related to the brand associated with a first university represented by the logo “CU.” Also displayed are relative perceptual mappings for other universities, e.g., “WCU” and “ECU.” The perception measurement system 130 can create the perceptual map by subjecting the association strengths of brands to multidimensional scaling techniques or other ordination techniques.

Each branding content association is represented by a dot disposed within the three concentric circles. The branding content associations can be common branding content associations that were input for sessions, e.g., surveys, related to the brand of each university. For example, the branding content associations may have been collected from surveys for a variety of branding content for each university, e.g., images of mascots, slogans, university symbols, etc.

The perceptual map 300 illustrates the associations that the survey participants have with respect to the university CU and its competitors, WCU and ECU, and the relative strengths of each association. For example, the university “CU” is more strongly associated with “Prestigious,” “Research” and “Engineering,” than the universities of WCU and ECU. However, WCU is more strongly associated with “Value,” “Entrepreneurial,” and “California” than the universities of CE and ECU; and the university ECU is more strongly associated with “Conservative,” “Traditional,” and “Economics” than are the universities of CU and WCU.

FIG. 4 is an illustration of a brand competitive profile 400 based on perception data received from the administration of psychometric tools. The brand competitive profile 400 can, for example, depict association strengths of two or more competitors. Each set of association strengths is relatively scaled and disposed on an axis extending horizontally from each association, and are color coded to their corresponding brand. In the example shown, association strength increases along the axis from left to right. Thus, the university CU is more strongly associated with “Smart” than is the university ECU; the university ECU is more strongly associated with “Economics” than is the university CU, etc.

Other graphical representations of the association data can also be used.

### §4.0 Example Process Flows

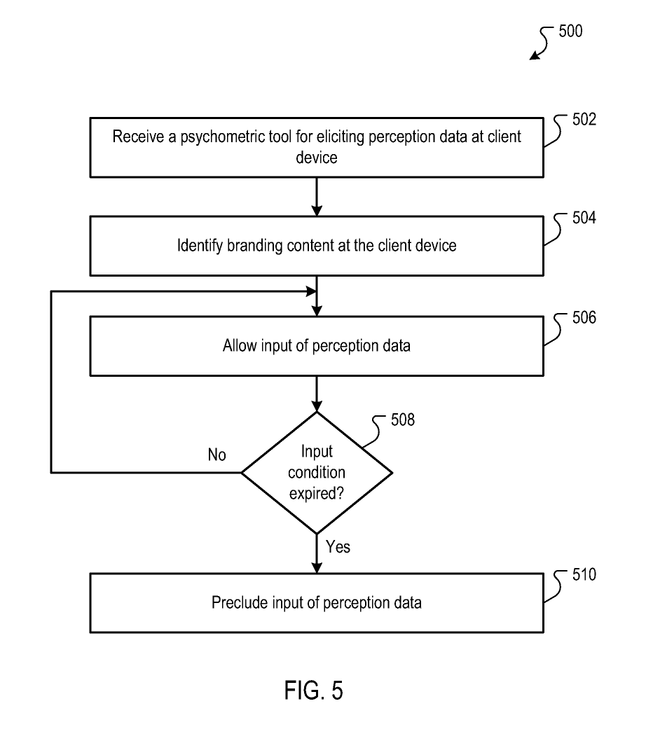

FIG. 5 is a flow diagram of an example process 500 for administering a psychometric tool. The process 500 can, for example, be implemented in a client device 108, or in other software and hardware devices that can process data according to the actions set forth below.

Stage 502 receives a psychometric tool for eliciting perception data at a client device. For example, the client device 108 can receive the psychometric tool 134 in the psychometric tool code 140 in response to a user clicking on an advertisement, or in response to a user requesting to participate in a session. In some implementations, the psychometric tool can be a branding survey, and the perception data can be associations. Other psychometric tools can also be used, e.g., Likert scales applied to images or other associations, etc.

Stage 504 identifies branding content at the client device. For example, the client device 108 can receive the branding content 132 in the psychometric code 140 in response to a user clicking on an advertisement, or in response to a user requesting to participate in a session. Alternatively, the psychometric tool code 140 can identify the branding content, e.g., can pose a question related to a brand name or product, but not show a brand logo.

Stage 506 allows input of perception data. For example, the client device 108 executing the psychometric tool code 140 can allow the input of perception data at the client device. The input of the perception data can be subject to an input condition so that input of the perception data is precluded when the expiry status of the input condition is true and input of the perception data is allowed when the expiry status of the input condition is false.

Stage 508 determines if an input condition has expired. For example, the client device 108 executing the psychometric tool code 140 can determine if a countdown clock has reached 0 seconds.

If stage 508 determines that the input condition has not expired, then the process returns to stage 506. For example, if the client device 108 executing the psychometric tool code 140 determines that the countdown clock has not reached 0 seconds, the process returns to stage 506.

If, however, stage 508 determines that the input condition has expired, then stage 510 precludes the further input of perception data. For example, if the client device 108 executing the psychometric tool code 140 determines that the countdown clock has reached 0 seconds, then the input of perception data can be precluded, e.g., by indicating the psychometric tool session has been completed, or by starting another psychometric tool session.

Corresponding process stages for the process 500 can likewise be performed by the perception measurement system 130. For example, the perception measurement system 130 can send the psychometric tool code 140 to a client device. Additionally, the perception measurement system 130 can identify branding content for the client device, e.g., by either providing a question regarding branding content 132 or sending actual branding content 132 to the client device 108. The psychometric tool code 140 can include the psychometric tool 134 that subjects the input of the perception data to an input condition.

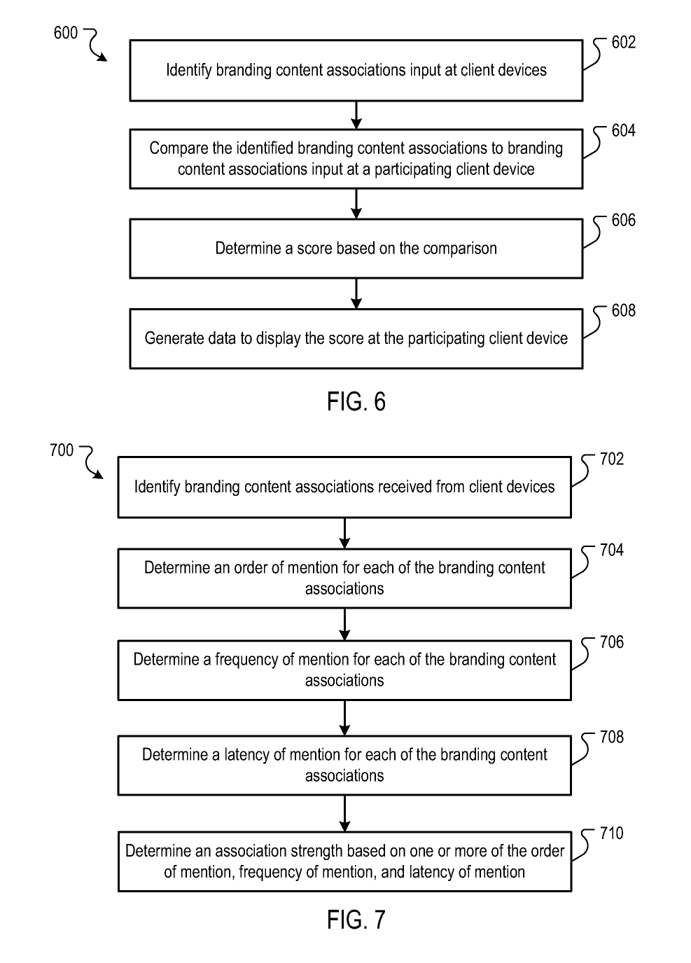

FIG. 6 is a flow diagram of an example process 600 for generating a score for display on a device on which a psychometric tool is being administered. The process 600 can, for example, be implemented in the perception measurement system 130 of FIG. 1, or in a client device executing the psychometric tool code 140, or in other software and hardware devices that can process data according to the actions set forth below.

Stage 602 identifies branding content associations input at other client devices. For example, the perception measurement system 130 can identify branding content associations received from a client device that is paired with previously collected participant data, or from paired client devices that are simultaneously a psychometric tool using a process flow such as illustrated in FIG. 5. Alternatively, the client device 108 executing the psychometric tool code 140 can receive branding content associations from a paired client device that is simultaneously executing the psychometric tool, or can receive previously collected participant data.

Stage 604 compares the identified branding content associations to branding content associations input at a participating client device. For example, the perception measurement system 130 can compare received branding content associations to branding content associations input at a participating client device. Alternatively, the client device 108 executing the psychometric tool code 140 can compare the branding content associations input at the client device to the received branding content associations.

Stage 606 determines a score based on the comparison. For example, the perception measurement system 130 can determine a score based on the comparison. Alternatively, the client device 108 executing the psychometric tool code 140 can determine a score based on the comparison.

Stage 608 generates data to display the score at the participating client device. For example, the perception measurement system 130 can generate data to display the score at the participating client device, e.g., a score parameter that is transmitted to the client device 108. Alternatively, the client device 108 executing the psychometric tool code 140 can generate the data to display the score at the participating client device.

FIG. 7 is a flow diagram of an example process 700 for determining a strength of association based on perception data received in response to administrations of psychometric tools. The process 700 can, for example, be implemented in the perception measurement system 130 of FIG. 1, or in other software and hardware devices that can process data according to the actions set forth below.

Stage 702 identifies branding content associations received from client devices. For example, the perception measurement system 130 can identify branding content associations received from multiple session of the psychometric tool related to a brand that have been conducted on multiple user devices. The branding content associations can be stored in the psychometric tool data 136, for example.

Stage 704 determines an order of mention for each of the brand content associations. For example, the perception measurement system 130 can determine the order of mention that identifies an order in which the branding content associations are input at each user device 108 in the aggregate and/or on a per-user device basis. The perception measurement system 130 can determine the order of mention by aggregating all perception data received according to a central tendency, e.g., an average or median position in which the branding content associations are received. The order of mention or each branding content association on a per-session basis can also be determined and stored.

Stage 706 determines a frequency of mention for each of the branding content associations. For example, the perception measurement system 130 can determine frequency of mention data that identifies a frequency measure for each branding content association. In some implementations, the frequency measure can include a measure of the occurrence of a corresponding branding content association being input relative to all of the branding content associations being input. Other frequencies of mention can also be used.

Stage 708 determines a latency of mention for each of the branding content associations. For example, the perception measurement system 130 determines a latency of mention that includes a measure of an input of a corresponding branding content association relative to input times of other branding content associations input during an administration of the psychometric tool. In some implementations, the perception measurement system 130 can aggregate the latency of mention for all branding content associations received according to a central tendency, e.g., an average or median time in which the branding content associations were input at the user devices.

Stage 710 determines an association strength based on one or more of the order of mention, frequency of mention, and latency of mention. For example, the perception measurement system 130 can determine association strengths based on one or more of the order of mention data, frequency of mention data and the latency of mention data of the branding content associations. In some implementations, the association strength for each branding content association can be inversely proportional to the latency of mention of the branding content association, and directly proportional to the frequency of mention and the order of mention of the branding content association. The association strengths can be determined according to different functional relationships, such as a logarithmic function of the order of mention, latency of mention and frequency of mention can be used so that association strengths asymptotically approach a maximum and/or minimum limit. Other relations can also be used, e.g., linear and non-linear functions based on the order of mention, frequency of mention, and latency of mention data. In other implementations, association strengths can be partitioned according to each of the order of mention, frequency of mention, and latency of mention.

The systems and methods described above can be used to not only measure brand perceptions of existing brand content, but can also be used to measure brand perception of proposed branding content. For example, an advertiser may consider a new advertising logo to include in a campaign. Before doing so, the advertiser may conduct on-line branding research using the psychometric tool described above to determine whether the perceptions and associations are favorable or desirable. Such prospective psychometric tool sessions can be readily implemented in the systems and method described above.

### §5.0 Example Processing System

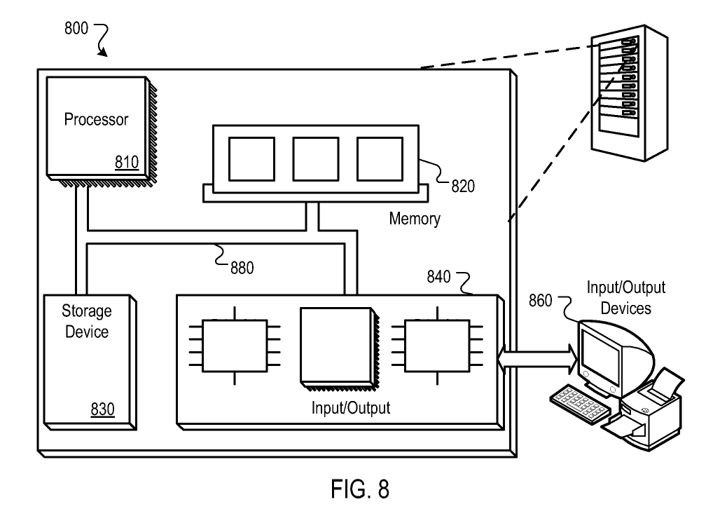

FIG. 8 is block diagram of an example computer processing system 800 that can be used to facilitate measuring participant perceptions. The system 800 can be used to realize a variety of different types of computer devices, such as the user devices 108 or server and computer devices on which the advertising system 104 and the perception measurement system 130 are implemented.

The system 800 includes a processor 810, a memory 820, a storage device 830, and an input/output device 840. Each of the components 810, 820, 830, and 840 can, for example, be interconnected using a system bus 860. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 can include one or more of a network interface devices, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 860. Other implementations, however, can also be used, such as mobile computing devices, mobile communication devices, set-top box television client devices, etc.

Although an example processing system has been described in FIG. 8, embodiments of the subject matter and the functional operations described in this specification can be implemented in other digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine readable storage device, a machine readable storage substrate, a memory device, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying Figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A non-transitory computer readable medium storing instructions executable by a processing device and that upon such execution cause the processing device to perform operations comprising:
providing, by a processing device, a psychometric tool to a plurality of client devices, the psychometric tool directed to the branding content and including an input interface that instructs a participant at a client device to input perception data before an expiration of an input condition during an administration of the psychometric tool at the client device;
pairing, by the processing device, at least one participant at a first client device to which the psychometric tool was provided with one or more other participants at respective second client devices to which the psychometric tools were provided;
receiving, from the client devices, branding content associations collected from sessions of psychometric tools for branding content at the client devices, each branding content association being generated from an input of the psychometric tool;
determining, by the processing device, branding content associations received from the psychometric tools provided to the first and second client devices that match and determining a score based on the matching branding content associations received and providing the score for display in the input interface of the psychometric tools provided to the first and second client devices;
for each branding content association:
determining an order of mention for the branding content association based on a central tendency of an order in which the branding content association was input at each of a plurality of the client devices, the order of mention for the branding content association being a measure of the order in which the branding content association was input at each of the plurality of client devices;
determining a frequency of mention for the branding content association, the frequency of mention for the branding content association being a measure of input occurrences of the branding content association at the plurality of client devices relative to input occurrences of all the branding content associations input at the client devices;
determining a latency of mention for the branding content association, the latency of mention for the branding content association based on a central tendency of respective input times at which the branding content association was input at each of the plurality of client devices, the latency of mention for the branding content association being a measure of an input time of the branding content association relative to the input times of other branding content associations input at the plurality of client devices; and
for each branding content association, determining an association strength that measures a strength of association of the branding content association to the branding content, the association strength based on the order of mention, frequency of mention and the latency of mention of the branding content association.

2. (canceled)

3. The computer readable medium of claim 1, wherein the association strength for each branding content association is inversely proportional to the latency of mention of the branding content association.

4. The computer readable medium of claim 1, wherein the association strength for each branding content association is directly proportional to the frequency of mention of the branding content association.

5. The computer readable medium of claim 1, wherein the association strength for each branding content association is directly proportional to the order of mention of the branding content association.

6. The computer readable medium of claim 1, wherein the association strength for each branding content association is proportional to the frequency of mention divided by a logarithmic value based on order of mention.

7. The computer readable medium of claim 1, wherein the association strength for each branding content association is proportional to the frequency of mention divided by a logarithmic value based on latency of mention.

8-9. (canceled)

10. A computer-implemented method performed by a data processing apparatus, comprising:
providing, by a data processing apparatus, a psychometric tool to a plurality of client devices, the psychometric tool directed to the branding content and including an input interface that instructs a participant at a client device to input perception data before an expiration of an input condition during an administration of the psychometric tool at the client device;
pairing, by the data processing apparatus, at least one participant at a first client device to which the psychometric tool was provided with one or more other participants at respective second client devices to which the psychometric tools were provided;
receiving, from the client devices, branding content associations collected from sessions of psychometric tools for branding content at the client devices, each branding content association being generated from an input of the psychometric tool;
determining, by the data processing apparatus, branding content associations received from the psychometric tools provided to the first and second client devices that match and determining a score based on the matching branding content associations received and providing the score for display in the input interface of the psychometric tools provided to the first and second client devices;
for each branding content association:
determining, by a data processing apparatus, an order of mention for the branding content association based on a central tendency of an order in which the branding content association was input at each of a plurality of the client devices, the order of mention for the branding content association being a measure of the order in which the branding content association was input at each of the plurality of client devices;
determining, by the data processing apparatus, a frequency of mention for the branding content association, the frequency of mention for the branding content association being a measure of input occurrences of the branding content association at the plurality of client devices relative to input occurrences of all the branding content associations input at the client devices;
determining, by the data processing apparatus, a latency of mention for the branding content association based on a central tendency of respective input times at which the branding content association was input at each of the plurality of client devices, the latency of mention for the branding content association being a measure of an input time of the branding content association relative to the input times of other branding content associations input at the plurality of client devices; and
for each branding content association, determining, by the data processing apparatus, an association strength that measures a strength of association of the branding content association to the branding content, the association strength based on the order of mention, frequency of mention and the latency of mention of the branding content association.

11. The method of claim 10, wherein the association strength for each branding content association is inversely proportional to the latency of mention of the branding content association.

12. The method of claim 10, wherein the association strength for each branding content association is directly proportional to the frequency of mention of the branding content association.

13. The method of claim 10, wherein the association strength for each branding content association is directly proportional to the order of mention of the branding content association.

14. The method of claim 10, wherein the association strength for each branding content association is proportional to the frequency of mention divided by a logarithmic value based on order of mention.

15. The method of claim 10, wherein the association strength for each branding content association is proportional to the frequency of mention divided by a logarithmic value based on latency of mention.

16-18. (canceled)

19. A system, comprising:
a data processing apparatus; and
a memory storage device in data communication with the data processing apparatus and comprising a computer readable medium storing instructions executable by the data processing apparatus and that upon such execution cause the data processing apparatus to perform operations comprising:
providing a psychometric tool to a plurality of client devices, the psychometric tool directed to the branding content and including an input interface that instructs a participant at a client device to input perception data before an expiration of an input condition during an administration of the psychometric tool at the client device;
pairing, by the processing device, at least one participant at a first client device to which the psychometric tool was provided with one or more other participants at respective second client devices to which the psychometric tools were provided;
receiving, from the client devices, branding content associations collected from sessions of psychometric tools for branding content at the client devices, each branding content association being generated from an input of the psychometric tool;
determining, by the processing device, branding content associations received from the psychometric tools provided to the first and second client devices that match and determining a score based on the matching branding content associations received and providing the score for display in the input interface of the psychometric tools provided to the first and second client devices;
for each branding content association:
determining an order of mention defining for the branding content associations based on a central tendency on an order in which the branding content association were input at each of a plurality of the client devices, the order of mention for the branding content association being a measure of the order in which the branding content association was input at each of the plurality of client devices;
determining a frequency of mention for the branding content association, the frequency of mention for the branding content association being a measure of input occurrences of the branding content association at the plurality of client devices relative to input occurrences of all the branding content associations input at the client devices; and
determining a latency of mention for the branding content association, the latency of mention for the branding content association based on a central tendency of respective input times at which the branding content association was input at each of the plurality of client devices and being a measure of an input time of the branding content association relative to the input times of other branding content associations input at the client devices; and
for each branding content association, determining an association strength that measures a strength of association of the branding content association to the branding content, the association strength based on the order of mention, frequency of mention and the latency of mention of the branding content association.
